(19) United States
(12) Patent Application Publication
(10) Pub. No.: US 2018/0236912 A1
(43) Pub. Date: Aug. 23, 2018

(54) SEAT ASSEMBLY WITH INTEGRATED HEAD RESTRAINT MOTOR

(71) Applicant: GM GLOBAL TECHNOLOGY OPERATIONS LLC, Detroit, MI (US)

(72) Inventors: LEIGH A. BERGER, BRIGHTON, MI (US); DANIEL W. BOOTH, TROY, MI (US); STEPHANIE RADION, BLOOMFIELD HILLS, MI (US); HEIDI MCADOO-WILSON, ONTARIO (CA)

(73) Assignee: GM GLOBAL TECHNOLOGY OPERATIONS LLC, Detroit, MI (US)

(21) Appl. No.: 15/438,300

(22) Filed: Feb. 21, 2017

(51) Int. Cl. B60N 2/48

(52) U.S. Cl. CPC B60N 2/4829

(57) ABSTRACT

A seat assembly includes a seat bottom and a seat back extending along a first axis and coupled to the seat bottom for receiving a vehicle occupant. The seat back includes a seat back frame with at least a first cross-member extending parallel to a second axis, perpendicular to the first axis. The seat assembly further includes a head restraint assembly with a head restraint and at least one head restraint post that supports the head restraint on the seat back. The seat assembly further includes a motor at least partially housed within the first cross-member of the seat back frame and configured to selectively generate an output torque. The seat assembly further includes a drive assembly coupled to the motor and the head restraint assembly to receive the output torque and, in response, translate the head restraint in at least one direction parallel to the first axis.

The present invention generally relates to vehicle seat assemblies, and more particularly relates to head restraint adjustment systems of vehicle seat assemblies.

A seat assembly, such as a vehicle seat assembly, often includes a head restraint mounted on a seat back. It is generally desirable to be able to move the head restraint between a variety of positions for occupant comfort and safety. In some arrangements, the head restraint is mounted on posts with detents and locking elements that enable manual adjustments of the head restraint relative to the seat back. More modern head restraint systems may include electric motors to facilitate adjustment. However, such additional equipment may occupy too much room in the seat and compromise occupant comfort and/or the ability to implement other features, such as heating elements, drive assistance actuators, and seat back adjustment components.

Accordingly, it is desirable to provide improved head restraint adjustment systems for seat assemblies. Furthermore, other desirable features and characteristics of the present invention will become apparent from the subsequent detailed description of the invention and the appended claims, taken in conjunction with the accompanying drawings and the background of the invention.

### SUMMARY

In an embodiment, a seat assembly includes a seat bottom and a seat back extending along a first axis and coupled to the seat bottom for receiving a vehicle occupant. The seat back includes a seat back frame with at least a first cross-member extending parallel to a second axis, perpendicular to the first axis. The seat assembly further includes a head restraint assembly with a head restraint and at least one head restraint post that supports the head restraint on the seat back. The seat assembly further includes a motor at least partially housed within the first cross-member of the seat back frame and configured to selectively generate an output torque. The seat assembly further includes a drive assembly coupled to the motor and the head restraint assembly to receive the output torque and, in response, translate the head restraint in at least one direction parallel to the first axis.

In a further embodiment, a seat assembly includes a seat bottom and a seat back extending along a first axis and coupled to the seat bottom for receiving a vehicle occupant. The seat back includes a seat back frame with at least a first cross-member extending parallel to a second axis, perpendicular to the first axis. The seat assembly further includes a head restraint assembly comprising a head restraint and at least one head restraint post that supports the head restraint on the seat back. The seat assembly further includes a motor at least partially housed within the seat back and configured to selectively generate an output torque. The seat assembly further includes a drive assembly coupled to the motor and the head restraint assembly to receive the output torque and, in response, translate the head restraint in at least one direction parallel to the first axis relative to the seat back and the at least one head restraint post.

In a further embodiment, method is provided for adjusting a head restraint in a vehicle seat assembly. The method includes generating an output torque with a motor within a cavity of a cross-member of a seat back frame; and translating the head restraint in at least a first direction by transferring the output torque into a translational force with a drive assembly extending between the motor and the head restraint.

### BRIEF DESCRIPTION OF THE DRAWINGS

The present invention will hereinafter be described in conjunction with the following drawing figures, wherein like numerals denote like elements, and

FIG. 1 is a schematic side view of a seat assembly in accordance with an exemplary embodiment;

FIG. 2 is a rear isometric view of a frame arrangement of the seat assembly of FIG. 1 in accordance with an exemplary embodiment;

FIG. 3 is a rear view of a head restraint adjustment system of the seat assembly of FIG. 1 in accordance with an exemplary embodiment;

FIG. 4 is a partial rear isometric view of the head restraint adjustment system of FIG. 3 in accordance with an exemplary embodiment;

FIG. 5 is a partial isometric view of a linkage cover and post guide of a head restraint adjustment system in accordance with another exemplary embodiment;

FIG. 6 is a partial view of a linkage cover in accordance with a further exemplary embodiment;

FIG. 7 is a rear isomeric view of a motor within a mounting bracket of a head restraint adjustment system in accordance with another exemplary embodiment;

FIG. 8 is a rear cross-sectional view of a head restraint adjustment system in accordance with a further exemplary embodiment;

FIG. 9 is a partial fragmentary cross-sectional view of a head restraint adjustment system in accordance with another exemplary embodiment;

FIG. 10 is a side view of a carousel gear arrangement of the head restraint adjustment system of FIG. 9 in accordance with an exemplary embodiment;

FIG. 11 is a partial isometric rear view of a head restraint adjustment system in accordance with an exemplary embodiment;

FIG. 12 is a cross-sectional view of a bracket component of a head restraint adjustment system in accordance with another exemplary embodiment; and

FIG. 13 is a rear perspective view of a head restraint adjustment system in accordance with another exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

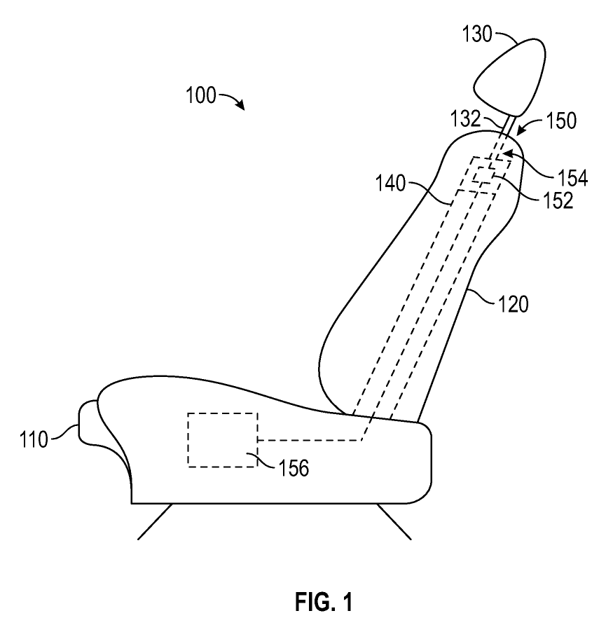

FIG. 1 is a schematic side view of a seat assembly 100 according to an exemplary embodiment. The seat assembly 100 may be installed on a floor of the passenger area of a vehicle. In one exemplary embodiment, the seat assembly 100 is a driver seat for an automobile, although in other exemplary embodiments, the seat assembly 100 may be a passenger seat and/or implemented into any type of vehicle.

As shown in FIG. 1, the seat assembly 100 includes a seat bottom 110, a seat back 120, and a head restraint 130. The seat bottom 110 defines a generally horizontal surface for supporting an occupant (not shown). The seat back 120 may be pivotally coupled to the seat bottom 110 and defines a generally vertical surface for supporting the back of an occupant. Generally, the seat bottom 110 and seat back 120 may be considered to include a resilient material (e.g., a foam body) (not shown) mounted on a frame arrangement 140 (schematically shown) and covered with a cover (not shown). The head restraint 130 is operatively coupled to the seat back 120 to support the head of an occupant. In one exemplary embodiment, the head restraint 130 may be coupled to the seat back 120 with one or more head restraint posts 132. Collectively, the head restraint 130 and head restraint posts 132 may be considered a head restraint assembly. Although not shown in FIG. 1, the head restraint 130 may also be constructed with a foam body mounted on a frame and covered with a cover.

As described in greater detail below, the seat assembly 100 further includes a head restraint adjustment system 150, portions of which may be incorporated into the seat bottom 110, seat back 120, and/or head restraint 130. Generally, the head restraint adjustment system 150 functions to reposition the head restraint 130 relative to the seat back 120 to improve the comfort and/or safety of the particular occupant. For example, the head restraint adjustment system 150 may reposition the head restraint 130 in an “up” direction (e.g., away from the seat back 120) and/or a “down” direction (e.g., toward the seat back 120). Depending on the embodiment, the head restraint adjustment system 150 may operate to adjust the head restraint 130 relative to the head restraint posts 132 (and thus, relative to the seat back 120) or to adjust the head restraint posts 132 (and thus, the head restraint 130) relative to the seat back 120. Further details are provided below.

As schematically depicted in FIG. 1, the head restraint adjustment system 150 may include a motor 152 mounted within the frame arrangement 140 that selectively generates an output torque. A drive assembly 154 is operatively coupled between the motor 152 and the head restraint 130 to adjust the position of the head restraint 130 in response to the output torque of the motor 152. The motor 152 may be coupled to a power source (not shown), such as the battery of the vehicle, and may be operated based on input signals from an input device 156. For example, the input device 156 may include input elements (e.g. switches, buttons, etc.) that actuate the motor 152 to adjust the head restraint 130 in the up direction or the down direction. In one embodiment, the motor 152 may be operated to produce a first output torque in a first direction to adjust the head restraint 130 in the up direction and a second output torque in a second direction to adjust the head restraint 130 in the down direction. In FIG. 1, the input device 156 is arranged on the side of the seat bottom 110. However, the input device 156 may be arranged in any suitable location, including on the vehicle console, vehicle door, and/or steering wheel, as examples.

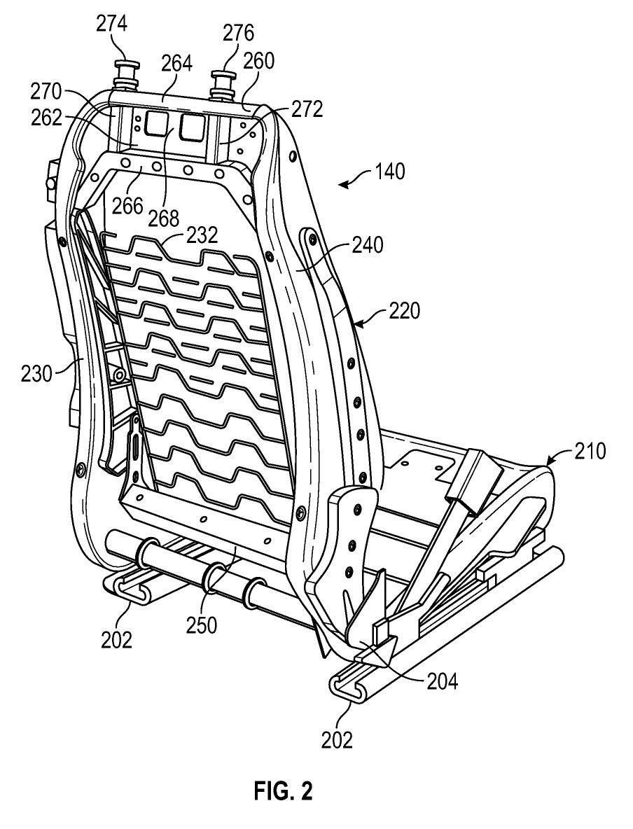

FIG. 2 is a rear isometric view of a frame arrangement 140 of the seat assembly 100 of FIG. 1 according to an exemplary embodiment. In the view of FIG. 2, most of the other components of the seat assembly 100 have been removed for clarity in the depiction of the frame arrangement 140.

Generally, the frame arrangement 140 may be considered to include mounting rails 202 that couple the frame arrangement 140 and seat assembly 100 to the floor of the vehicle. The frame arrangement 140 generally includes a seat bottom frame 210 and a seat back frame 220. The seat bottom frame 210 forms a portion of the seat bottom 110 (FIG. 1) and is mounted on the mounting rails 202. The seat back frame 220 forms a portion of the seat back 120 and is pivotably mounted to the seat bottom frame 210 via a pivot assembly 204.

In one exemplary embodiment, the seat back frame 220 may be considered to include a first side frame member 230, a second side frame member 240, a lower frame cross-member 250, and an upper frame cross-member 260. Generally, the first and second side frame members 230, 240 extend along the left and right sides of the seat back frame 220, parallel to a longitudinal axis of the seat back frame 220 (or, generally vertical when the seat back frame 220 is in an upright position). The lower and upper frame cross-members 250, 260 extend between the first and second side frame members 230, 240, parallel to a lateral axis of the seat back frame 220 (or, generally horizontal). As shown, the first and second side frame members 230, 240 and lower and upper frame cross-members 250, 260 form a generally rectangular arrangement. In one exemplary embodiment, the first and second side frame members 230, 240 and lower and upper frame cross-members 250, 260 are formed by one or more separate pieces, although in various embodiments, one or more may be integral with one another.

As shown, the first and second side frame members 230, 240 may be coupled to the pivot assembly 204 to enable the back frame 220 to pivot relative to the bottom frame 210. Further, an interior webbing 232 may extend between the first and second side frame members 230, 240 to provide support and/or structure for the body (not shown) of the seat assembly 100.

In one embodiment, the upper frame cross-member 260 may define a cavity 262. For example, the upper frame cross-member 260 may be considered to have a top cross-member element 264 and an interior cross-member element 266, each extending between the first and second side frame members 230, 240 at a distance from one another to define the cavity 262. As shown in FIG. 2, the upper frame cross-member 260 may be open on a rear face to allow access to the cavity 262. In one particular embodiment, the upper frame cross-member 260 may have a partial or complete plate 268 to partially or completely close the forward face of the cavity 262, although other arrangements may be provided.

As shown in FIG. 2, one or more cylindrical post guides 270, 272 may extend through the cavity 262. Typically, the post guides 270, 272 extend through the top cross-member element 264, through the cavity 262, and to the interior cross-member element 266, although in some embodiments, the post guides 270, 272 may extend through the interior cross-member element 266. One or more cylindrical post sheaths or covers 274, 276 may be provided on or proximate to a top face of the top cross-member element 264. The post sheathes 274, 276 may circumscribe a portion of the post guides 270, 272 that extend beyond the top face of the top cross-member element 264.

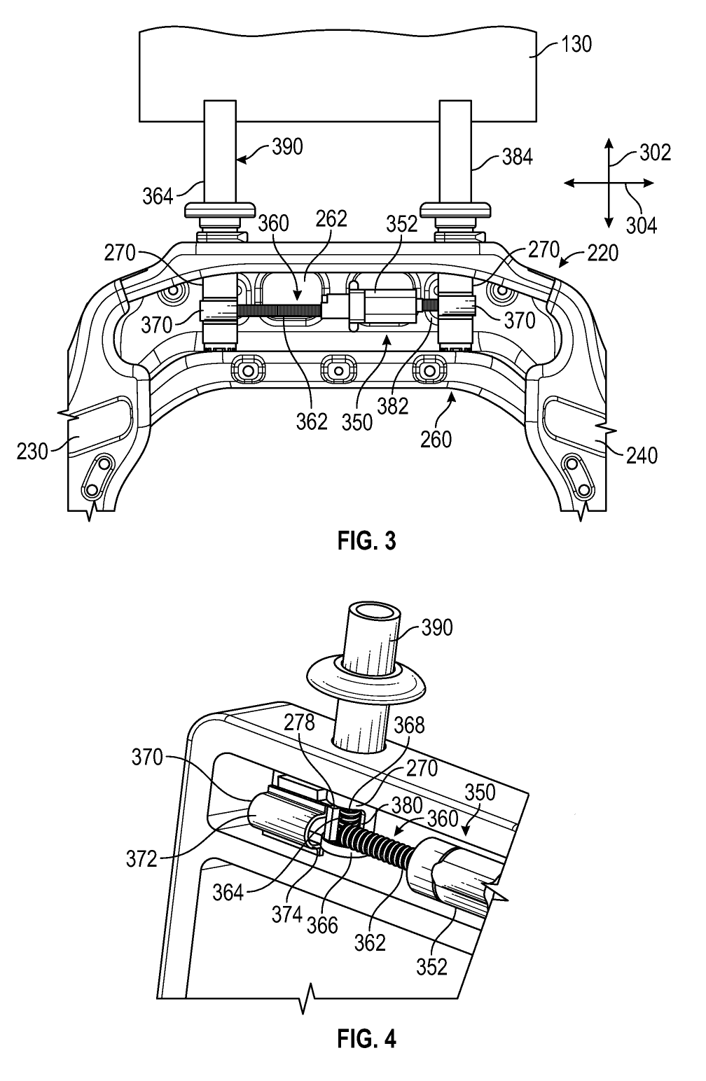

As described above in reference to FIG. 1, the seat assembly 100 may include a head restraint adjustment system 150 to adjust the head restraint 130 relative to the seat back 120. The head restraint adjustment system 150 may have various arrangements, as will be described with reference to FIGS. 3-13.

FIG. 3 is a partial rear side view of a head restraint adjustment system 350 generally corresponding the head restraint adjustment system 150 introduced above. Portions of the head restraint adjustment system 350 in FIG. 3 are incorporated into a seat back frame 220 such as described above with reference to FIG. 2, although other embodiments may have different frame configurations. FIG. 3 particularly depicts the upper frame cross-member 260 and portions of the first and second side frame members 230, 240. The body and the cover of the seat back 120 have been removed in the depiction of FIG. 3, while a portion of the head restraint 130 is shown.

The head restraint adjustment system 350 includes a motor 352 (e.g., corresponding to motor 152 introduced in FIG. 1) positioned partially or completely within the cavity 262 of the upper frame cross-member 260. In one exemplary embodiment, the cavity 262 and/or motor 352 are sized such that the motor 352 is completely accommodated by the cavity 262. As shown, the motor 352 is particularly positioned in between the first and second post guides 270, 272 that extend through the cavity 262. In some embodiments, the motor 352 may be positioned in other locations within the seat back 120, such as above the upper frame cross-member 260 or below the upper frame cross-member 260.

As introduced above, the head restraint adjustment system 350 further includes a drive or linkage assembly 360 that functions to transfer the output torque of the motor 352 into a force that translates the head restraint 130 in one or more directions. As noted above, the head restraint 130 is configured to be adjusted at least in a first direction and a second direction (e.g., up and down) relative to the seat back frame 220. In this discussion below, the first and second directions are considered to be parallel to a first (or generally longitudinal) axis 302.

In one embodiment, the drive assembly 360 includes a first drive shaft 362 coupled to (or connected to) an output element of the motor 352. As shown, the first drive shaft 362 extends from the motor 352 to the first post guide 270 in a direction generally parallel to a second (or lateral) axis 304, which is perpendicular to the first axis 302. As described in greater detail below, the first drive shaft 362 is configured to engage a second drive shaft 364 to transfer the output torque from the motor 352.

Generally, the second drive shaft 364 is at least partially arranged within the first post guide 270 and extends in a direction parallel to the first axis 302 between the first drive shaft 362 and the head restraint 130. In the view of FIG. 3, only the portions of the second drive shaft 364 extending beyond the top of the first post guide 270 are visible.

In FIG. 3, a transmission arrangement between the first and second drive shafts 362, 364 is obscured by a linkage cover 370. The linkage cover 370 functions to maintain the engagement between the first and second drive shafts 362, 364.

Additional reference is made to FIG. 4, which is a partial rear isometric view of the head restraint adjustment system 350 of FIG. 3 in which the linkage cover 370 has been moved to the left to better show the engagement between the first and second drive shafts 362, 364. The post guide 270 defines a window 380 through which the first drive shaft 362 engages the second drive shaft 364. Each of the first and second drive shafts 362, 364 is provided with worm gear elements 366, 368 that engage one another to transfer force. In this exemplary embodiment, the worm gear elements 366, 368 interact such that the torque of the rotating first drive shaft 362 translates the second drive shaft 364 in a direction parallel to the first axis 302. In particular, rotation of the first drive shaft 362 in a first direction functions to translate the second drive shaft 364 in an up direction, and rotation of the first drive shaft 362 in a second direction functions to translate the second drive shaft 364 in a down direction.

Now referring to both FIGS. 3 and 4, the second drive shaft 364 extends through the post guide 270 to the head restraint 130. The distal end of the second drive shaft 364 is fixed to the head restraint 130 such that translation of the second drive shaft 364 also adjusts the head restraint 130. As such, selective actuation of the motor 352 operates to reposition the head restraint 130 via the first and second drive shafts 362, 364.

In the embodiment of FIGS. 3 and 4, the second drive shaft 364 may be considered to be integral with, or function as, a head restraint post 390 that extends between the seat back 120 and the head restraint 130 to support the head restraint 130. In other embodiments, the distal end of the second drive shaft 364 may be fixed to the head restraint post 390, which in turn is fixed to the head restraint 130, such that the second drive shaft 364, head restraint post 390, and head restraint 130 move as unit. In a further embodiment, the head restraint post 390 may be hollow such that the second drive shaft 364 extends through the head restraint post 390. In such an embodiment, the second drive shaft 364 may move the head restraint 130 independently of the head restraint post 390. In other words, some exemplary embodiments enable an arrangement in which the motor 352 is arranged in a seat back 120 and functions to reposition the head restraint 130 relative to the stationary head restraint posts 390 (e.g. along the head restraint posts 390 rather than the head restraint posts 390 and head restraint 130 moving together as a unit).

As best shown in FIG. 4 and introduced above, the linkage cover 370 is generally configured to maintain engagement between the first and second drive shafts 362, 364. In one example, the linkage cover 370 generally has a C-shape that extends around the post guide 270 from a side opposite the motor 352. The rear face 372 of the linkage cover 370 protrudes to accommodate the first drive shaft 362 and is sized to maintain the engagement between the first and second drive shafts 362, 364. The linkage cover 370 may be made from a resilient material such that, during assembly upon positioning the first drive shaft 362 relative to the second drive shaft 364, the linkage cover 370 may be inserted from the side opposite the motor 352 around the post guide 270. The linkage cover 370 may flex slightly while sliding over the post guide 270 and return to the original shape such that the ends 374 of the linkage cover 370 are positioned on the other side of the post guide 270 to maintain the linkage cover 370 in both lateral directions. In effect, the linkage cover 370 may form a “snap” fit during assembly. In some embodiments, the post guide 270 may include a flange 278, as well as other features, to assist the linkage cover 370 in mating with the post guide 270.

The discussion above focuses on one side of the head restraint adjustment system 350. Corresponding components of the drive assembly 360 may function in a similar manner on the other side. For example, a third drive shaft 382 extends from the opposite side of the motor 352 to the first drive shaft 362 in a direction parallel to the first axis 302. The third drive shaft 382 engages a fourth drive shaft 384 that extends through the post guide 272 to the head restraint 130. As such, the output torque of the motor 352 may be used to translate the head restraint 130 up and down in a manner similar to the operation discussed above. Typically, the third and fourth drive shafts 382, 384 work in conjunction with the first and second drive shafts 362, 364 such that each side of the head restraint 130 is raised and lowered evenly.

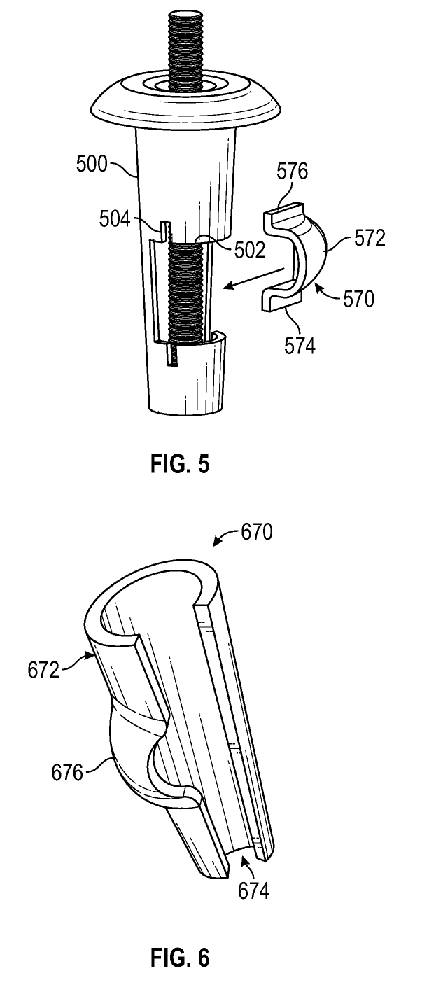

FIG. 4 depicts one embodiment of the linkage cover 370 that maintains engagement between the first and second drive shafts 362, 364. However, other arrangements may be provided. FIG. 5 is a partial isometric view of a linkage cover 570 and post guide 500 in accordance with another embodiment. In FIG. 5, the linkage cover 570 and post guide 500 have been removed from other portions of the head restraint adjustment system; however, the linkage cover 570 and post guide 500 may be incorporated into any embodiments of the head restraint adjustment system discussed herein.

As shown in FIG. 5, the linkage cover 570 has an extended or protruding center portion 572 and upper and lower flange sections 574, 576. The post guide 500 defines a window 502 with one or more vertical slots 504 (one of which is shown) on either side. The vertical slot 504 enables insertion of the upper and lower flange sections 574, 576 on the slot side of the window 502 such that the linkage cover 570 may be slid across the window 502. Upon insertion, the upper and lower edges of the window 502 retain the upper and lower flange sections 574, 576 and thus the linkage cover 570. The protruding center portion 572 is shaped and sized to accommodate the first drive shaft (not shown) that mates with the second drive shaft (not shown).

FIG. 6 is a partial view of a linkage cover 670 in accordance with a further exemplary embodiment. In FIG. 6, the linkage cover 670 has been removed from other portions of the head restraint adjustment system; however, the linkage cover 670 may be incorporated into any embodiment of the head restraint adjustment system discussed herein. In this embodiment, the linkage cover 670 includes a cylindrical body 672 with a split 674 that enables the linkage cover 670 to fit around the post guide (not shown) at the window (not shown). The linkage cover 670 further includes a protruding portion 676 to accommodate the first drive shaft such that, upon installation, the linkage cover 670 functions to maintain the engagement between the first and second drive shafts (not shown).

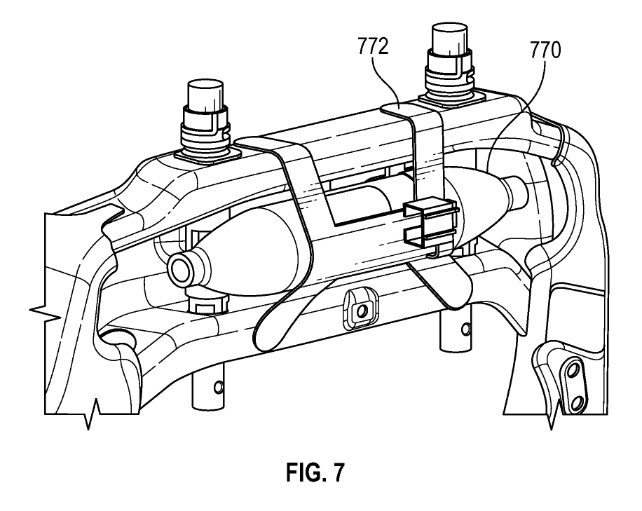

Reference is briefly made to FIG. 7, which is a rear isometric view of an integrated cover 770 that may be incorporated into head restraint adjustment system 350 such as shown in FIG. 3. As shown in FIG. 7, the cover 770 may have a cylindrical body that encloses the motor (not shown) and tapered ends that enclose the engagements of the first and second drive shafts (not shown) and third and fourth drive shafts (not shown) to function, in effect, as linkage covers. The cover 770 may be coupled to the upper cross-member with straps or a bracket 772.

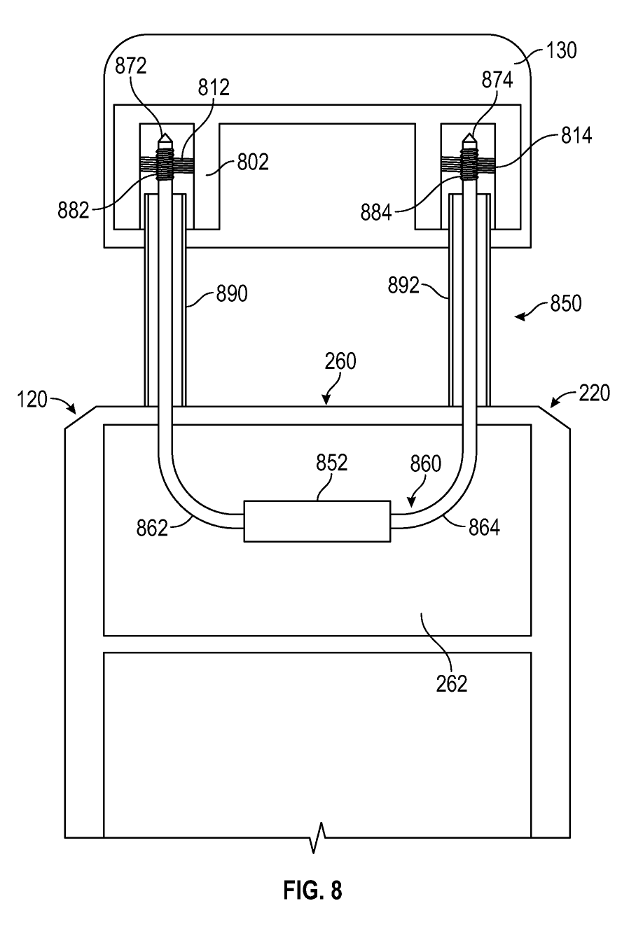

FIG. 8 is a rear cross-sectional view of a head restraint adjustment system 850 according to a further exemplary embodiment. In particular, FIG. 8 depicts the upper frame cross-member 260 of the back frame 220. As above, the head restraint adjustment system 850 includes a motor 852 positioned in the cavity 262 of the upper frame cross-member 260. Although not shown, in some embodiments, post guides may be provided in the cavity 262.

A drive assembly 860 includes first drive shaft 862 extending between the motor 852 and the head restraint 130. In this embodiment, the first drive shaft 862 is a flexible cable that rotates upon receipt of the output torque of the motor 852. In particular, the first drive shaft 862 is initially oriented in a lateral direction and bends to a longitudinal direction. The first drive shaft 862 extends through a head restraint post 890 supporting the head restraint 130. A distal end 872 of the first drive shaft 862 includes threaded element 882.

In this embodiment, the head restraint 130 includes a housing element 802 that receives the first drive shaft 862 and the head restraint post 890. The housing element 802 includes a threaded portion 812 that engages that threaded element 882 of the first drive shaft 862. During operation, rotation of the threaded element 882 of the first drive shaft 862 drives the threaded portion 812 of the head restraint 130 such that the housing element 802, and thus the head restraint 130, translates relative to the head restraint post 890 and seat back 120.

As above, the head restraint adjustment system 850 includes corresponding elements on the other side. In particular, a second drive shaft 864 extends between the motor 852 and head restraint 830 through a head restraint post 892. The second drive shaft 864 includes a threaded element 884 on a distal end 874 that engages a threaded portion 814 in the housing element 802 to translate the head restraint 130.

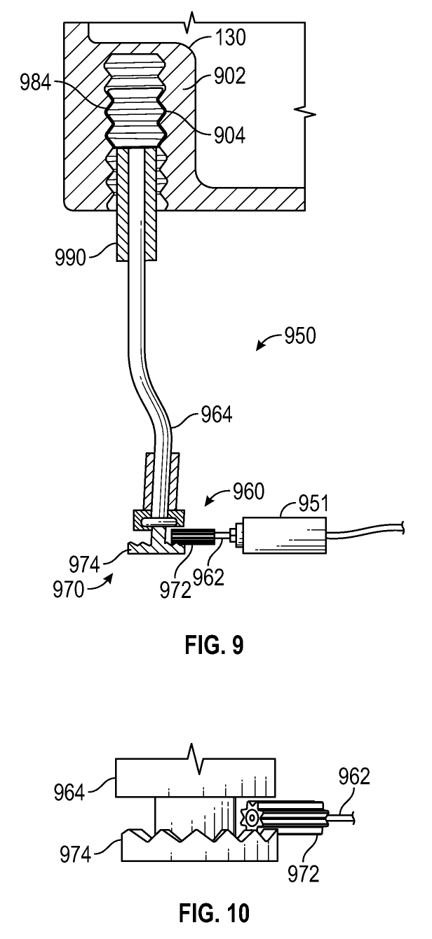

FIG. 9 is a partial fragmentary cross-sectional view of a head restraint adjustment system 950 in accordance with another exemplary embodiment. As above, the head restraint adjustment system 950 includes a motor 252 positioned in the cavity of an upper frame cross-member (not shown in FIG. 9).

In this embodiment, a drive assembly 960 includes first drive shaft 962 and second drive shaft 964. The first drive shaft 962 extends in a lateral direction between the motor 252 and the second drive shaft 964, and the second drive shaft 964 extends in a generally longitudinal direction between the first drive shaft 962 and the head restraint 130. In this embodiment, the second drive shaft 964 extends through the head restraint post 990 (partially shown).

The first and second drive shafts 962, 964 are coupled together with a carousal gear arrangement 970. In particular, the first drive shaft 962 is provided with a gear element 972 having laterally extending teeth. The second drive shaft 964 is provided with a circular gear element 974 having radially extending teeth mounted to rotate about an axis. As the first drive shaft 962 rotates, the gear element 972 engages the cooperating gear element 974 of the second drive shaft 964 to rotate the second drive shaft 864. FIG. 10 provides a closer, schematic representation of the gear elements 972, 974 of the first and second drive shafts 962, 964 that function to transfer the rotational torque along the lateral axis to rotational torque along the longitudinal axis.

Returning to FIG. 9, in this embodiment, the head restraint 130 includes a head restraint housing element 902 configured to receive the distal end of the second drive shaft 964 and the head restraint post 990. As shown, the housing element 902 is provided with internal threads 904 that engage corresponding threaded elements 984 of the second drive shaft 964.

Accordingly, during operation, rotation of the threaded elements 984 of the second drive shaft 964 engages the internal threads 904 of the housing element 902 to translate the head restraint 130 relative to the head restraint post 990 and seat back 120. Although not shown, corresponding elements may be provided on the other side such that both sides of the head restraint 130 may cooperate to evenly translate the head restraint 130.

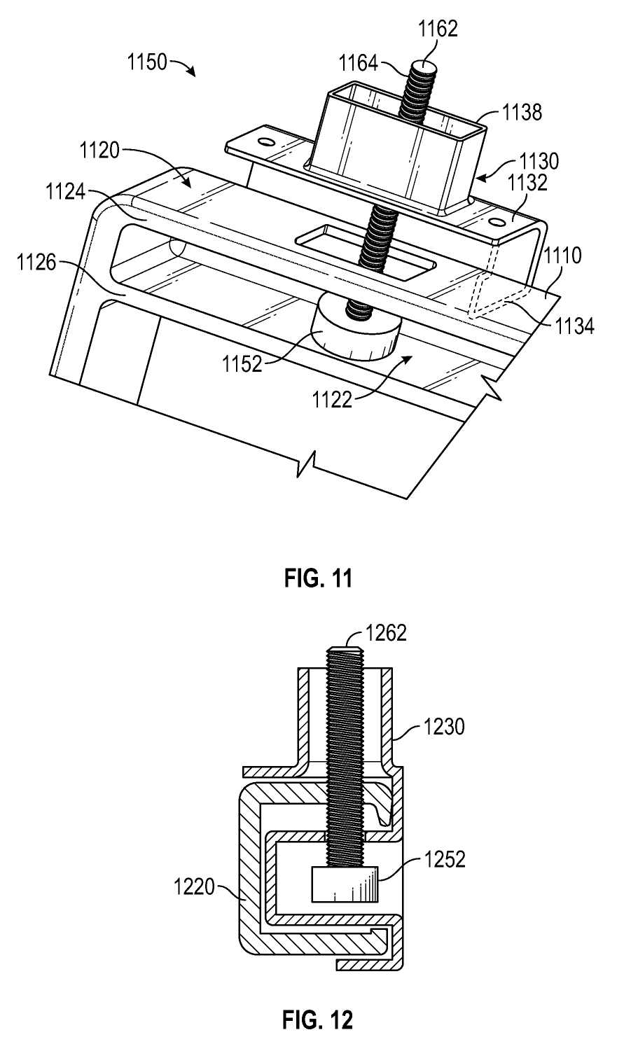

In the embodiments discussed above, the head restraint is generally supported by two head restraint posts with one head restraint posts arranged on either side. However, the embodiments described herein are also applicable to center mounted head restraints that are mounted on a single head restraint post. Exemplary embodiments of center mounted head restraints will be described below with reference to FIGS. 11-13.

FIG. 11 is a partial isometric rear view of a head restraint adjustment system 1150 according to an exemplary embodiment. In this embodiment, a back frame 1110 is provided with an upper cross-member 1120 that defines a cavity 1122 between a top cross-member element 1124 and an interior cross-member element 1126.

In this embodiment, a bracket component 1130 has a C-shaped configuration with an upper flange 1132 engaging the top side of the top cross-member element 1124 and a lower flange 1134 engaging the underside of the interior cross-member element 1126. In FIG. 11, the bracket component 1130 is in a position just prior to assembly with the upper cross-member 1120. The bracket component 1130 additionally includes a longitudinally extending bracket post 1138 that supports the head restraint (not shown). In effect, the bracket post 1138 functions in a manner similar to the head restraint posts discussed above.

In this embodiment, a motor 1152 is arranged within the cavity 1122 of the upper cross-member 1120. A first drive shaft 1162 extends in a longitudinal direction from the motor 1152, through a passage in the top cross-member element 1124, through the bracket component 1130, and to the head restraint. The first drive shaft 1162 may have threaded elements 1164 that engage corresponding thread elements in a housing element of the head restraint. For example, the head restraint that cooperates with the embodiment of FIG. 11 may have elements similar to those discussed above with reference to FIG. 9, albeit with a single element arranged in the center of the head restraint rather than two such elements arranged on either side of the head restraint. In some embodiments, at least a portion of the motor 1152 may extend into the bracket post 1138 of the bracket component 1130.

In the embodiment of FIG. 11, the bracket component 1130 engages the front face of the upper cross-member 1120. However, other configurations may be provided. As an example, FIG. 12 depicts a cross-sectional view of a bracket component 1230 that may be incorporated into the head restraint adjustment system 1150 of FIG. 11. In this embodiment, the bracket component 1230 is shaped to engage the rear (or open) face of the upper cross-member 1220. As schematically shown, the bracket component 1230 may have openings to accommodate the motor 1252 and first drive shaft 1264 may be arranged therein to drive the head restraint (not shown).

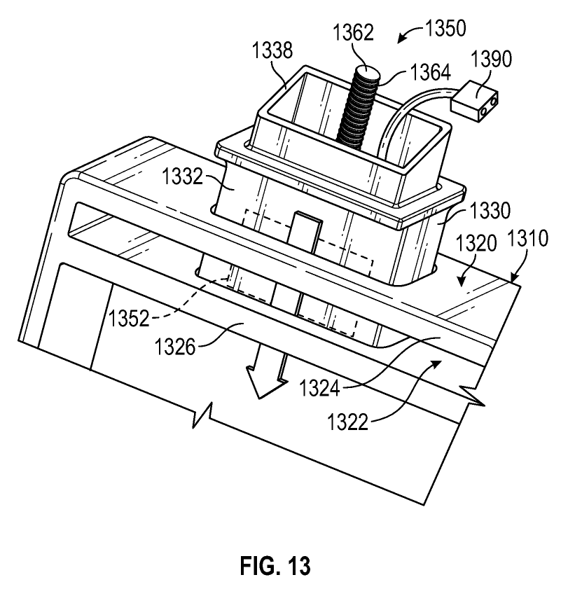

FIG. 13 is a rear perspective view of a head restraint adjustment system 1350 in accordance with another exemplary embodiment. In this embodiment, a back frame 1310 is provided with an upper cross-member 1320 that defines a cavity 1322 between a top cross-member element 1324 and an interior cross-member element 1326.

In this embodiment, a bracket component 1330 has an extended bottom flange 1332 sized and shaped to engage a correspondingly shaped passage in the top cross-member element 1324. In effect, the bottom flange 1332 of the bracket component 1330 is inserted into the passage in the top cross-member element 1324, as shown in FIG. 13. Similar to the embodiment of FIG. 11, the bracket component 1330 of FIG. 13 includes a longitudinally extending bracket post 1338 that supports the head restraint (not shown).

As above, a motor 1352 is arranged within the cavity 1322 of the upper cross-member 1320, and a first drive shaft 1362 extends in a longitudinal direction from the motor 1352, through the passage in the top cross-member element 1324, through the bracket component 1330, and to the head restraint (not shown). The first drive shaft 1362 may have threaded elements 1364 that engage corresponding thread elements in a housing element of the head restraint. For example, the head restraint that cooperates with the embodiment of FIG. 13 may have elements similar to those discussed above with reference to FIG. 9, albeit with a single element arranged in the center of the head restraint rather than two such elements arranged on either side of the head restraint. As also shown in FIG. 13, the bracket component 1330 may accommodate a power connection 1390 that electrically couples the motor 1352 to a power source (not shown).

Accordingly, exemplary embodiments of improved head restraint adjustment systems have been described. Such embodiments include a motor integrated within a cavity of an upper cross-member of the frame arrangement and/or with linkage and drive assemblies that do not require movement of the head restraint posts. This enables a more compact and integrated construction. As a result, additional areas of the seat back and/or head restraint are available for other components, such as speakers, ventilation, massage elements, actuators, and the like.

While at least one exemplary aspect has been presented in the foregoing detailed description of the invention, it should be appreciated that a vast number of variations exist. It should also be appreciated that the exemplary aspect or exemplary aspects are only examples, and are not intended to limit the scope, applicability, or configuration of the invention in any way. Rather, the foregoing detailed description will provide those skilled in the art with a convenient road map for implementing an exemplary aspect of the invention. It being understood that various changes may be made in the function and arrangement of elements described in an exemplary aspect without departing from the scope of the invention as set forth in the appended claims.

What is claimed is:

1. A seat assembly, comprising:
a seat bottom;
a seat back extending along a first axis and coupled to the seat bottom for receiving a vehicle occupant, the seat back including a seat back frame with at least a first cross-member extending parallel to a second axis, perpendicular to the first axis;
a head restraint assembly comprising a head restraint and at least one head restraint post that supports the head restraint on the seat back;
a motor at least partially housed within the first cross-member of the seat back frame and configured to selectively generate an output torque; and
a drive assembly coupled to the motor and the head restraint assembly to receive the output torque and, in response, translate the head restraint in at least one direction parallel to the first axis.

2. The seat assembly of claim 1, wherein the seat back frame includes first and second side members, and wherein the first cross-member includes a top cross-member element and an interior cross-member element extending between the first and second side members, the top cross-member element and the interior cross-member element defining a cavity that houses the motor.

3. The seat assembly of claim 2, wherein the drive assembly includes a first drive shaft extending generally parallel to the second axis and a second drive shaft extending generally parallel to the first axis, the first drive shaft receiving the output torque from the motor and engaging second drive shaft to transfer the output torque into translation of the second drive shaft, the head restraint being coupled to the second drive shaft to translate with the second drive shaft.

4. The seat assembly of claim 3, wherein the at least one seat post houses at least a portion the second drive shaft and translates with the second drive shaft and the head restraint.

5. The seat assembly of claim 3, wherein the first drive shaft includes first gear elements and the second drive shaft includes second gear elements, the first and second gear elements forming a worm gear.

6. The seat assembly of claim 3, further comprising a linkage cover to couple the first gear elements to the second gear elements.

7. The seat assembly of claim 6, wherein the first gear elements engage the second gear elements within the cavity of the first cross-member.

8. The seat assembly of claim 3, wherein the at least one head restraint post is a first head restraint post housing the portion of the second drive shaft, and the at least one head restraint post includes a second head restraint post extending between the seat back and the head restraint, and
wherein the drive assembly further comprises a third drive shaft extending generally parallel to the second axis on a side of the motor opposite of the first drive shaft and a fourth drive shaft extending generally parallel to the first axis,
the third drive shaft also receiving the output torque from the motor and engaging fourth drive shaft to transfer the output torque into translation of the second drive shaft, the head restraint being coupled to the fourth drive shaft to translate with the fourth drive shaft.

9. The seat assembly of claim 2, wherein the drive assembly includes at least a first threaded housing element arranged within the head restraint,
the drive assembly further including a first drive shaft extending from the motor to engage the first threaded housing element such that receipt of the output torque of the motor rotates the first drive shaft that, in turn, translates the first threaded housing element and the head restraint in the at least one direction.

10. The seat assembly of claim 9, wherein the first draft shaft is a flexible drive shaft cable.

11. The seat assembly of claim 10, wherein the flexible drive shaft cable extends at least partially through the at least one head restraint post between the motor and the first threaded housing element within the head restraint.

12. The seat assembly of claim 2, further comprising a bracket coupling the at least one head restraint post to the first cross-member of the seat back frame.

13. The seat assembly of claim 12, wherein the bracket is integrated with the at least one head restraint post.

14. The seat assembly of claim 12, wherein the at least one head restraint post is a center head restraint post and the drive assembly extends through the center head restraint post.

15. The seat assembly of claim 14, further comprising a power connection extending from a power source, through the center head restraint post, to the motor.

16. The seat assembly of claim 12, wherein the top cross-member element defines a passage, and wherein the motor extends at least partially through the passage.

17. The seat assembly of claim 2,
wherein the drive assembly includes at least a first threaded housing element arranged within the head restraint,
wherein the drive assembly includes a first drive shaft extending generally parallel to the second axis and a second drive shaft extending generally parallel to the first axis, the first drive shaft receiving the output torque from the motor and engaging second drive shaft to rotate the second drive shaft with the output torque, the second drive shaft engaging the first threaded housing element to transfer the output torque into translation of the first threaded housing element and the head restraint.

18. The seat assembly of claim 17, wherein the first drive shaft and the second drive shaft form a carousel gear.

19. A seat assembly, comprising:
a seat bottom;
a seat back extending along a first axis and coupled to the seat bottom for receiving a vehicle occupant, the seat back including a seat back frame with at least a first cross-member extending parallel to a second axis, perpendicular to the first axis;
a head restraint assembly comprising a head restraint and at least one head restraint post that supports the head restraint on the seat back;
a motor at least partially housed within the seat back and configured to selectively generate an output torque; and
a drive assembly coupled to the motor and the head restraint assembly to receive the output torque and, in response, translate the head restraint in at least one direction parallel to the first axis relative to the seat back and the at least one head restraint post.

20. A method of adjusting a head restraint in a vehicle seat assembly, comprising the steps of:
generating an output torque with a motor within a cavity of a cross-member of a seat back frame; and
translating the head restraint in at least a first direction by transferring the output torque into a translational force with a drive assembly extending between the motor and the head restraint.
